(19) United States
(12) Patent Application Publication
(10) Pub. No.: US 2022/0007682 A1
(43) Pub. Date: Jan. 13, 2022

(54) METHOD FOR PREPARING AN IPP- AND VPP-RICH HYDROLYSATE FROM WHEAT GLUTEN PROTEIN BY ENZYMATIC HYDROLYSIS

(71) Applicant: Qingdao Agricultural University, Qingdao (CN)

(72) Inventors: Guoqing Huang, Qingdao (CN); Junxia Xiao, Qingdao (CN); Zhikai Zhang, Qingdao (CN); Huiqin Zhou, Qingdao (CN); Liping Guo, Qingdao (CN); Xiaodan Li, Qingdao (CN); Jing Teng, Qingdao (CN)

(21) Appl. No.: 17/361,303

(22) Filed: Jun. 28, 2021

(30) Foreign Application Priority Data
Jul. 10, 2020 (CN) 202010660556.9

(51) Int. Cl. A23J 3/34; A23J 3/18; A23L 33/18

(52) U.S. Cl. CPC A23J 3/346; A23L 33/18; A23J 3/18

(57) ABSTRACT

A method for preparing IPP- and VPP-rich hydrolysate from wheat gluten protein by enzymatic hydrolysis is disclosed, comprising the following steps: (1) dissolving wheat gluten protein in an alkaline solution, and performing ultrasonic treatment; (2) adding the alkaline protease to the wheat gluten protein solution to hydrolyze; (3) adjusting the pH value of the alkaline hydrolysate to neutral or weakly acidic, and adding protease to hydrolyze, and inactivating the enzyme at a high temperature; (4) centrifuging the hydrolysate to obtain the supernatant, and ultrafiltrating with an ultrafiltration membrane; (5) decolorizing and debitterizing the permeate using a macroporous resin; (6) after the debittered and decolorized liquid is adsorbed by an ion exchange resin, eluting the ion exchange resin and drying, to obtain a powder of IPP- and VPP-rich hydrolysate. The preparation method has a high protein recovery rate, with rich IPP and VPP in the hydrolysate.

### CROSS-REFERENCE TO RELATED APPLICATIONS

The present application claims the benefit of Chinese Patent Application No. 202010660556.9 filed on Jul. 10, 2020, the contents of which are hereby incorporated by reference.

### FIELD OF THE INVENTION

The invention generally relates to a protein hydrolysis technology, and particularly to a method for preparing IPP- and VPP-rich hydrolysate from wheat gluten protein by enzymatic hydrolysis.

### BACKGROUND

Ile-Pro-Pro (IPP) and Val-Pro-Pro (VPP) are two peptides that have a definite effect on lowering blood pressure in the body. Because the two tripeptides and Leu-Pro-Pro (LPP) are initially produced from yogurt fermented by Lactobacillus helveticus, the three tripeptides are collectively called lactotripeptides, in which, IPP is located in the positions 74 to 76 of β-casein and the positions 84 to 86 of κ-casein, VPP is located at positions 108 to 110 of β-casein, and LPP is located at positions 151 to 153 of β-casein. IPP and VPP have definite preventive and therapeutic effects on patients with mild hypertension. At present, casein is the only source of lactotripeptides. In order to develop new types of antihypertensive products based on lactotripeptides, it is of great significance to find new sources of lactotripeptides other than casein.

Wheat is one of the most important crops in the world. The wheat gluten protein, a by-product of flour production, has an extremely rich source and high protein content. The wheat gluten protein is mainly composed of gliadin and glutenin, of which gliadin accounts for 40%-50% of the total wheat protein, and glutenin accounts for 30%-40% of the total wheat protein, in addition, the wheat gluten protein contains a small amount of starch, fiber, sugar, fat and minerals, etc. Among the amino acid compositions of wheat gluten protein, proline accounts for about 16% of the total amino acids, indicating that it may be a potential source of lactotripeptides. The query results of the amino acid sequences from the National Center of Biotechnology Information (NCBI) showed that the wheat gluten protein is a good source of IPP and VPP. If IPP and VPP can be released from wheat gluten protein in a targeted manner, it will be of great significance for finding new sources of lactotripeptides other than casein and improving the comprehensive utilization value of the wheat gluten protein.

### SUMMARY

The object of the present invention is to provide a method for preparing IPP- and VPP-rich hydrolysate from wheat gluten protein by enzymatic hydrolysis. The wheat gluten powder is subject to enzymatic hydrolysis by a variety of proteases, and then is refined to obtain the IPP- and VPP-rich hydrolysate. The preparation method has a high protein recovery rate, with rich IPP and VPP in the hydrolysate and definite blood pressure lowering effect in vivo.

To achieve the above object, the present invention adopts the following technical solutions.

The present invention provides a method for preparing IPP- and VPP-rich hydrolysate from wheat gluten protein by enzymatic hydrolysis, comprising the following steps:

(1) Dissolving wheat gluten protein in an alkaline solution of pH 9.0 to 13.0, and performing ultrasonic treatment to obtain a wheat gluten protein solution;

(2) Adding the alkaline protease to the wheat gluten protein solution to hydrolyze for 2 to 8 hours at 40˜60° C. to and 100˜150 r/min in a water bath shaker or a hydrolyzer, to obtain a hydrolysate;

(3) Adjusting the pH value of the hydrolysate to neutral or weakly acidic, and adding protease to hydrolyze, and hydrolyzing at 45˜75° C. and 100˜130 r/min for 2 to 6 hours, inactivating the enzyme at 100° C. for 10 to 15 minutes, to obtain a hydrolysate;

(4) Inactivating the hydrolysate, centrifuging to take the supernatant, ultrafiltrating with an ultrafiltration membrane, and collecting a permeate;

(5) Decolorizing and debitterizing the permeate using a macroporous resin to obtain a debittered and decolorized liquid;

(6) After the debittered and decolorized liquid is adsorbed by an ion exchange resin, eluting the ion exchange resin, to obtain an IPP- and VPP-rich hydrolysate;

(7) Drying the hydrolysate to obtain a powder of IPP- and VPP-rich wheat gluten protein hydrolysate.

Further, in the step (1), the alkaline solution is NaOH or NaCO₃ solution; and the ultrasonic treatment condition is power of 50 to 100 W and treatment time of 5 to 25 min;

Most preferably, the alkaline solution is NaCO₃ solution, and the ultrasonic treatment condition is power of 50 W and treatment time of 10 min.

Further, in the step (2), the alkaline protease is Alcalase 2.4L or Bacillus licheniformis 2709 alkaline protease; and the addition amount is 0.1˜3.0% of the weight of wheat gluten protein in the reaction system.

Most preferably, the alkaline protease is Alcalase 2.4L, and the addition amount is 0.5% of the weight of wheat gluten protein in the reaction system.

Further, the pH adjusting reagent used in the step (3) is 0.1 mol/L HCl or citric acid solution; the added protease is flavourzyme and compound protease or flavourzyme and papain; the addition amount of the protease is 0.1˜3.0% of the weight of wheat gluten protein in the reaction system.

Most preferably, the pH adjusting agent is citric acid, the protease used is a combination of flavourzyme and compound protease, and the addition amount is 0.3% of the weight of wheat gluten protein in the reaction system.

Further, in the step (4), the centrifugation condition is 5000 r/min for 20 minutes; the ultrafiltration membrane used in the ultrafiltration is a Biomax membrane with a molecular weight cut-off of 5000 Dal, and the inlet pressure is 25 psi, when no protein is detected in the permeate, namely, the end point of ultrafiltration, the permeate is collected.

Further, in the step (5), the resin is a XAD-16 macroporous resin, and the addition amount is 5˜25% (w/v), the pH of the feed liquid is 4.0 to 8.0, the decolorization temperature is 20° C. to 40° C., and the decolorization time is 0.5 h to 2.5 h.

Most preferably, the decolorization condition is addition amount of 5%, pH value of feed liquid of 5.0 to 7.0, temperature of 20° C., and decoloration time of 1.0 h.

Further, in the step (6), the ion exchange resin used is Na-type cation exchange resin, and the pH value of the feed liquid is 3.5 to 5.5; the adsorption method is to pass the feed liquid whose pH value is adjusted through ion exchange columns, then wash the columns with 3 to 5 times the bed volume of distilled water with a pH value of 3.5 to 5.5 until the effluent has no absorption at 220 nm.

Most preferably, the ion exchange resin used is type 732 cation exchange resin, and the pH value of the feed liquid is 5.0, and the columns are washed with 4 times the bed volume of distilled water with a pH value same as the feed liquid.

Further, the elution method of the ion exchange resin in the step (6) is to elute using a NaOH solution with a pH value of 10.5 until the eluate has no absorption at 220 nm.

Further, the drying method in the step (7) is spray drying or freeze drying.

Most preferably, the drying method is spray drying.

The present invention further provides IPP- and VPP-rich hydrolysate prepared by the method for preparing an IPP- and VPP-rich hydrolysate from wheat gluten protein by enzymatic hydrolysis.

The present invention further provides the application of IPP- and VPP-rich hydrolysate in preparing supplements for BP-lowering foods.

Compared with the prior art, the present invention has the following advantages and beneficial effects.

1. The method of the present invention has a high protein recovery rate of wheat gluten protein. IPP and VPP contain prolyl peptide bonds, and a variety of proteases are required to release IPP and VPP from the raw materials. The multi-enzyme system adopted in the invention has strong hydrolysis ability, which can deeply hydrolyze wheat gluten protein, in addition to the release of IPP and VPP. The whole enzymatic hydrolysis process has a high protein recovery rate and a high comprehensive utilization of wheat gluten proteins.

2. The debittering and decolorizing method of the hydrolysate of the present invention is simple and feasible. Since the wheat gluten protein is rich in hydrophobic amino acids, the hydrolysate has a strong bitter taste and dark color. At present, activated carbon is widely used to debitter and decolorize the hydrolysate, but the activated carbon cannot be reused and easily causes environmental pollution, and some peptides will be adsorbed by the activated carbon and lost. In the present invention, the macroporous adsorption resin is used for debittering and decolorizing, with a decolorization effect close to that of activated carbon. However, the macroporous resin can be reused, and the peptides adsorbed on the resin can be recycled. Therefore, the debittering and decolorizing method of wheat gluten protein hydrolysate in the present invention can not only reduce the emission of pollutants, but also can realize the comprehensive utilization of peptides and pigments.

3. The present invention uses wheat gluten protein as a raw material to obtain IPP- and VPP-rich hydrolysate by enzymatic hydrolysis, with high IPP and VPP contents and high protein recovery rate; in addition, IPP and VPP been clinically proven to have a definite blood pressure lowering effect in vivo, so the hydrolysate of the present invention has a definite blood pressure lowering effect in vivo, with a better market prospect.

### BRIEF DESCRIPTION OF THE DRAWINGS

FIG. 1 is a flow chart of preparing IPP and VPP hydrolysates according to the present invention.

FIG. 2A is a GC-MS/MS spectrum of IPP in the hydrolysate obtained in Example 5 of the present invention.

FIG. 2B is a GC-MS/MS spectrum of VPP in the hydrolysate obtained in Example 5 of the present invention.

FIG. 3 shows the effect of the pH value of the ultrafiltration permeate on the decolorization effect according to the present invention.

### DETAILED DESCRIPTION

The technical solution of the present invention will be further described in detail below with specific embodiments. The experimental methods without specific conditions in the following examples are usually in accordance with the conventional conditions, or the conditions recommended by the manufacturer. The materials without specifying the sources are all commercially available materials.

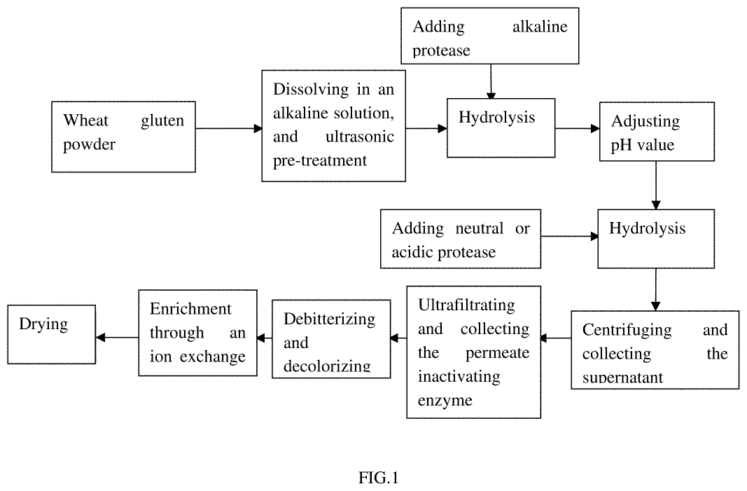

A method for preparing IPP- and VPP-rich hydrolysate from wheat gluten protein by enzymatic hydrolysis, having a flow chart as shown in FIG. 1, comprises the following steps:

1. Pretreatment of wheat gluten protein: Dissolving wheat gluten protein in NaOH solution or Na₂CO₃ solution of pH 9.0 to 13.0, and performing ultrasonic treatment at a power of 50˜100 W for 5 to 25 minutes to obtain a wheat gluten protein solution;

2. Hydrolysis of wheat gluten protein with an alkaline protease: Adding the Alcalase 2.4L or Bacillus licheniformis 2709 alkaline protease to the wheat gluten protein solution according to 0.1%˜3.0% of the weight of the wheat gluten protein, to hydrolyze for 2 to 8 hours at 40˜60° C. and 100˜150 r/min in a water bath shaker or hydrolyzer to obtain an alkaline hydrolysate.

3. Hydrolysis of wheat gluten protein with a neutral and acidic protease: Adjusting the pH value of the alkaline hydrolysate to neutral or weakly acidic with 0.1 mol/L HCl or citric acid solution, and adding flavourzyme and a compound protease, or a flavourzyme and a papain to the reaction system according to 0.1%-3.0% of the weight of the wheat gluten protein, hydrolyzing at 45˜75° C. and 100˜130 r/min for 2 to 6 hours, inactivating the enzyme at 100° C. for 10 to 15 minutes, to obtain a hydrolysate.

4. Ultrafiltration of wheat gluten protein hydrolysate: Inactivating the above hydrolysate, centrifuging to at 5000 r/min for 20 min to collect the supernatant, ultrafiltrating using a Biomax membrane with a molecular weight cut-off of 5000 Dal, with the inlet pressure of 25 psi, when no protein is detected in the permeate, namely, the end point of ultrafiltration, collecting the permeate.

5. Decolorization and debittering of ultrafiltration permeate: decolorizing the permeate using the XAD-16 type macroporous resin, with the addition amount of 5˜25% (w/v), and pH of the feed liquid of 4.0 to 8.0, decolorization temperature of 20˜40° C., decolorization time of 0.5 h to 25 h, to obtain a debittered and decolorized liquid.

6. Enrichment of IPP and VPP: Using Na-type cation exchange resin to enrich IPP and VPP in the debittered and decolorized liquid. Adjusting the pH value of the feed liquid to between 3.5 and 5.5, then flowing through the ion exchange column (IPP and VPP must not penetrate), and then washing the columns with 3 to 5 times the bed volume of distilled water with a pH value of 3.5 to 5.5, until the effluent has no absorption at 220 nm.

7. Elution of ion exchange resin: Perform elution using NaOH solution with pH value of 10.5 until the eluent has no absorption at 220 nm, and collecting the eluent, i.e. IPP- and VPP-rich hydrolysate.

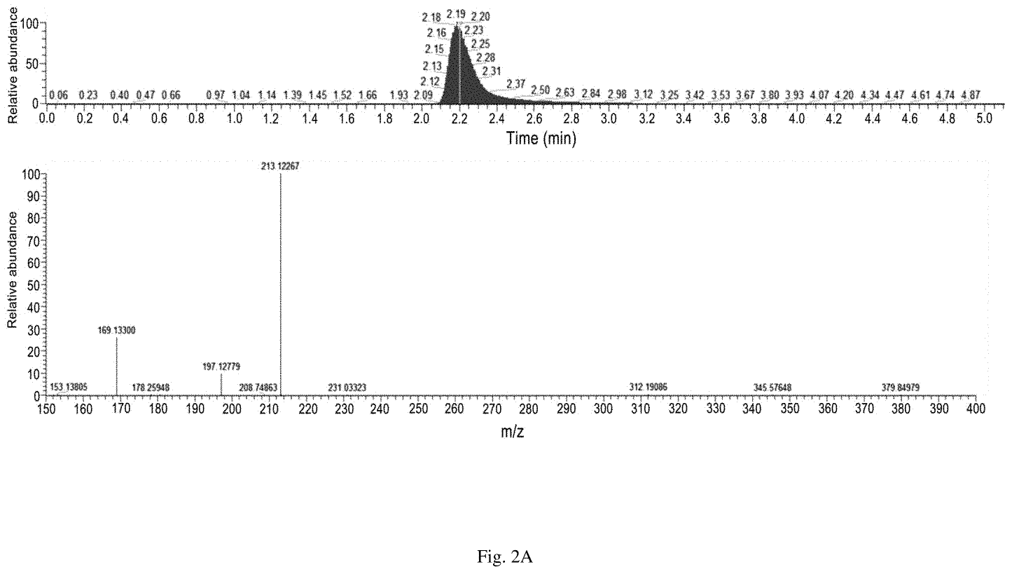

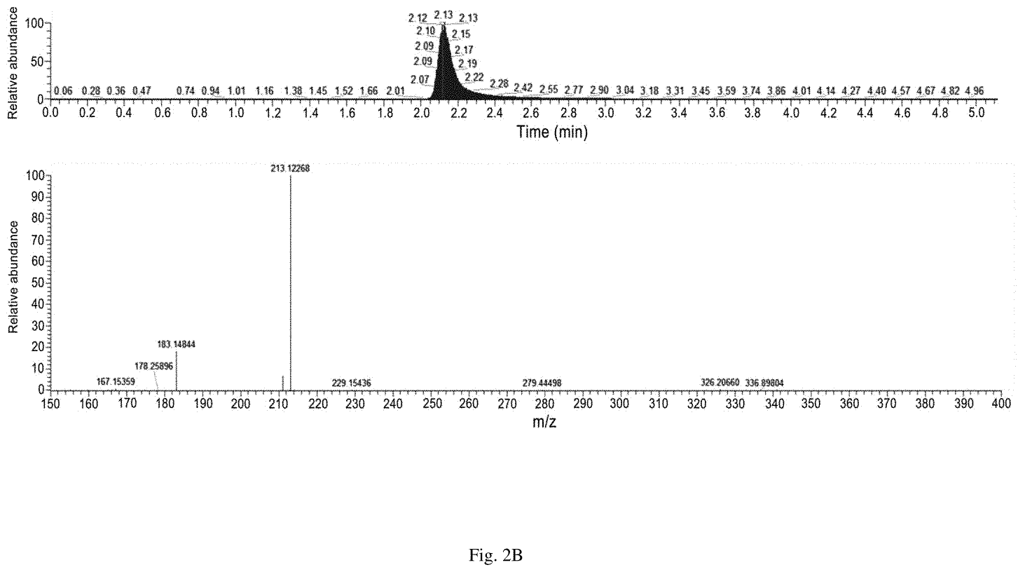

8. Drying of the hydrolysate: Drying the hydrolysate by spray drying or freeze drying to obtain a wheat gluten protein hydrolysate powder with low bitterness, light color, and rich in IPP and VPP. The mass spectrum is shown in FIG. 2A and FIG. 2B, respectively.

### Example 1

The wheat gluten protein was dissolved in a NaOH solution with a pH of 10.0, and then ultrasonically treated at a power of 50 W for 10 minutes; then Alcalase 2.4L alkaline protease was added according to the amount of 4000 U/g gluten protein powder, and hydrolyzed under the condition of 40° C. and 100 r/min magnetic stirring for 2 h, and then enzyme was inactivated at 100° C. for 10 minutes.

The above hydrolysate was adjusted to pH 6.5 with 1 mol/L HCl solution, the flavourzyme was added according to the amount of 50 LAPU/g wheat gluten protein powder, then hydrolysated for 2 h at a stirring speed of 100 r/min under a 50° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 4.0, then adsorbed, decolorized and debitterized for 0.5 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 47.6%, and the total content of IPP and VPP in the lyophilized powder was 0.038% (WAY).

### Example 2

The wheat gluten protein was dissolved in a NaOH solution with a pH of 10.0, and then ultrasonically treated at a power of 50 W for 10 minutes; then Alcalase 2.4L alkaline protease was added according to the amount of 4000 U/g gluten protein powder, and hydrolyzed under the condition of 40° C. and 100 r/min magnetic stirring for 2 h, and then enzyme was inactivated at 100° C. for 10 minutes.

The above hydrolysate was adjusted to pH 6.5 with 1 mol/L HCl solution, the flavourzyme was added according to the amount of 50 LAPU/g wheat gluten protein powder and the papain was added according to the amount of 4000 U/g wheat gluten protein powder, then hydrolysated for 2 h at a stirring speed of 100 r/min under a 50° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 4.0, then adsorbed, decolorized and debitterized for 0.5 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 57.6%, and the total content of IPP and VPP in the lyophilized powder was 0.061% (W/W).

### Example 3

The wheat gluten protein was dissolved in a Na₂CO₃ solution with a pH of 10.0, and then ultrasonically treated at a power of 75 W for 5 minutes; then Bacillus licheniformis 2709 alkaline protease was added according to the amount of 4000 U/g, and hydrolyzed under the condition of 45° C. and 100 r/min magnetic stirring for 2 h, and then enzyme was inactivated at 100° C. for 10 minutes.

The above hydrolysate was adjusted to pH 6.5 with 1 mol/L HCl solution and 1 mol/L NaOH solution, and 70 LAPU/g flavourzyme and 4000 U/g compound protease were added, then hydrolysated for 2 h at a stirring speed of 100 r/min under a 40° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 4.0, then adsorbed, decolorized and debitterized for 0.5 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 43.5%, and the total content of IPP and VPP in the lyophilized powder was 0.057% (W/W).

### Example 4

The wheat gluten protein was dissolved in a Na₂CO₃ solution with a pH of 10.0, and then ultrasonically treated at a power of 75 W for 5 minutes; then Alcalase 2.4L alkaline protease was added according to the amount of 6000 U/g wheat gluten powder, and hydrolyzed under the condition of 40° C. and 100 r/min magnetic stirring for 2 h, and then enzyme was inactivated at 100° C. for 10 minutes.

The above hydrolysate was adjusted to pH 6.5 with 1 mol/L HCl solution and 1 mol/L NaOH solution, and 90 LAPU/g flavourzyme and 5000 U/g papain were added, then hydrolysated for 2 h at a stirring speed of 100 r/min under a 40° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 4.0, then adsorbed, decolorized and debitterized for 1 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 63.5%, and the total content of IPP and VPP in the lyophilized powder was 0.096% (WAY).

### Example 5

The wheat gluten protein was dissolved in a Na₂CO₃ solution with a pH of 10.0, and then ultrasonically treated at a power of 75 W for 10 minutes; then Alcalase 2.4L alkaline protease was added according to the amount of 6000 U/g wheat gluten powder, and hydrolyzed under the condition of 40° C. and 100 r/min magnetic stirring for 2 h, and then enzyme was inactivated at 100° C. for 10 minutes.

The above hydrolysate was adjusted to pH 6.5 with 1 mol/L HCl solution and 1 mol/L NaOH solution, and 90 LAPU/g flavourzyme and 5000 U/g papain were added, then hydrolysated for 2 h at a stirring speed of 100 r/min under a 40° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 4.0, then adsorbed, decolorized and debitterized for 0.5 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 67.1%, and the total content of IPP and VPP in the lyophilized powder was 0.091% (WAY).

### Example 6

The wheat gluten protein was dissolved in a Na₂CO₃ solution with a pH of 10.0, and then ultrasonically treated at a power of 75 W for 10 minutes; then Alcalase 2.4L alkaline protease was added according to the amount of 6000 U/g gluten protein powder, and hydrolyzed under the condition of 40° C. and 100 r/min magnetic stirring for 2 h, and then enzyme was inactivated at 100° C. for 10 minutes.

The above hydrolysate was adjusted to pH 6.5 with 1 mol/L HCl solution and 1 mol/L NaOH solution, and 90 LAPU/g flavourzyme and 5000 U/g papain were added, then hydrolysated for 2 h at a stirring speed of 100 r/min under a 40° C. constant temperature water bath, and then the enzyme was inactivated at 100° C. for 10 min.

The hydrolysate was centrifuged at 10000 r/min for 15 min, the supernatant was collected, and ultrafiltered through a Biomax ultrafiltration membrane with a molecular weight cut-off of 5 kDa for 1 h at an inlet pressure of 15 PSI; the permeate was collected and adjusted to pH 7.0, then adsorbed, decolorized and debitterized for 0.5 h using a 5% (W/V) XAD-16 type macroporous resin. The decolorizing liquid flowed through a Na-type 732 cation exchange column, then the column was washed with 3 times the bed volume of distilled water with a pH of 4.0; elution was performed using a NaOH solution of pH 10.5 until the eluent had no absorption at 220 nm, then the eluent was collected, and spray drying was carried out.

Compared with the raw material wheat protein powder, the protein recovery rate of this process was 62.9%, and the total content of IPP and VPP in the lyophilized powder was 0.089% (W/W).

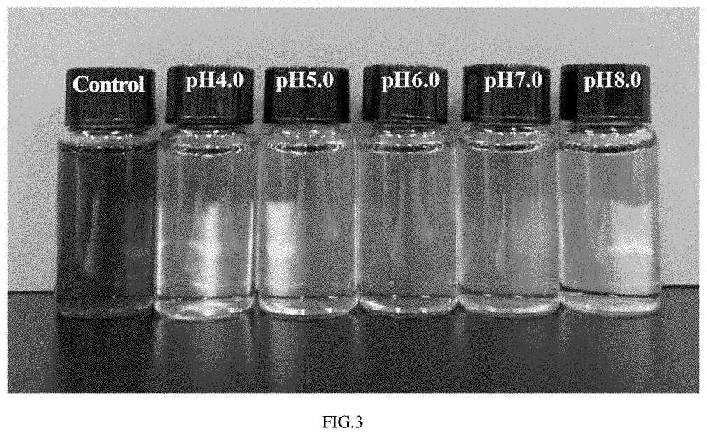

In summary, the above results showed that, since the wheat gluten protein has the characteristic of dissolving in alkaline solution, the hydrolysis with alkaline protease first under alkaline conditions plays an important role in improving the protein recovery rate. The type of alkaline protease has an important influence on this purpose. When the two alkaline proteases in the present invention are selected, the protein recovery rate is highest. In the process of protein hydrolysis, as the peptides are continuously released, the pH value of the reaction system will gradually decrease, which will adversely affect the active products of the alkaline protease. NaCO₃ has a strong buffering capacity, which can reduce the fluctuation of the pH value of the reaction system during the enzymatic hydrolysis process as much as possible without external intervention, so it is more conducive to the enzymatic hydrolysis process. Due to the specificity of flavourzyme, this enzyme is crucial to release IPP and VPP, but the addition of other proteases facilitates the further release of the two tripeptides and the improvement of the protein recovery. The hydrolysate has a darker color, so decolorization is an essential step. When selecting decolorization conditions, it is necessary to ensure that the decolorization effect is achieved while minimizing the non-specific absorption of IPP, VPP and other peptides, to improve the protein recovery rate of the entire process. XAD-16 can meet them very well. As shown in FIG. 3, the decolorization effect is better within the specified pH range of the present invention, and the loss rate of IPP, VPP and other peptides is lower. In addition, due to the low content of IPP and VPP in the initial hydrolysate, it is necessary to enrich them to reach a higher level. A cation exchange resin is the most widely used adsorbent in industrial production. Because IPP and VPP are amphoteric electrolytes, to allow them to be adsorbed on the ion exchange resin, the pH value of the feed liquid must be strictly controlled to make them positively charged. However, when eluting, NaOH solution with a high pH should be used to make them negatively charged for analysis. Therefore, within the scope of various operating parameters defined by the present invention, a wheat gluten protein hydrolysis process with high IPP and VPP content and protein recovery rate can be obtained.

The above embodiments are only used to illustrate the technical solutions of the present invention rather than limit them; although the present invention has been described in detail with reference to the foregoing embodiments, for those of ordinary skill in the art, the technical solutions of the foregoing embodiments can be modified, or some of the technical features can be equivalently substituted; these modifications or substitutions will not make the essence of the corresponding technical solutions to deviate from the spirit and scope of the technical solutions claimed by the present invention.

1. A method for preparing IPP- and VPP-rich hydrolysate from wheat gluten protein by enzymatic hydrolysis, comprising the following steps:
(1) dissolving wheat gluten protein in an alkaline solution, and performing ultrasonic treatment to obtain a wheat gluten protein solution; the alkaline solution is a Na₂CO₃ solution with a pH of 9.0 to 13.0; the ultrasonic treatment condition is power of 50 to 100 W and treatment time of 5 to 25 min;
(2) adding the alkaline protease to the wheat gluten protein solution to hydrolyze for 2 to 8 hours at 40˜60° C. to obtain an alkaline hydrolysate; the alkaline protease is Alcalase 2.4L or Bacillus licheniformis 2709 alkaline protease, with the addition amount of 0.1˜3.0% of the weight of wheat gluten protein in the reaction system;
(3) adjusting the pH value of the alkaline hydrolysate to neutral or weakly acidic, and adding protease to hydrolyze, and hydrolyzing at 45˜75° C. for 2 to 6 hours, inactivating the enzyme at a high temperature to obtain a hydrolysate; the protease is a flavourzyme and a compound protease, or a flavourzyme and a papain, whose addition amount is 0.1˜3.0% of the weight of the wheat gluten protein in the reaction system;
(4) inactivating the hydrolysate, centrifuging to take the supernatant, ultrafiltrating with an ultrafiltration membrane, and collecting a permeate;
(5) decolorizing and debitterizing the permeate using a macroporous resin to obtain a debittered and decolorized liquid;
(6) After the debittered and decolorized liquid is adsorbed by an ion exchange resin, eluting the ion exchange resin, to obtain an IPP- and VPP-rich hydrolysate;
(7) drying the hydrolysate to obtain a powder of IPP- and VPP-rich hydrolysate.

2. The method for preparing an IPP- and VPP-rich hydrolysate from wheat gluten protein by enzymatic hydrolysis according to claim 1, wherein, in the step (4), the ultrafiltration membrane is a Biomax membrane with a molecular weight cut-off of 5000 Dal and the inlet pressure is 25 psi.

3. The method for preparing an IPP- and VPP-rich hydrolysate from wheat gluten protein by enzymatic hydrolysis according to claim 1, wherein, in the step (5), the resin is a XAD-16 macroporous resin, and the addition amount is 5˜25% (w/v), the pH of the feed liquid is 4.0 to 8.0, the decolorization temperature is 20° C. to 40° C., and the decolorization time is 0.5 h to 2.5 h.

4. The method for preparing an IPP- and VPP-rich hydrolysate from wheat gluten protein by enzymatic hydrolysis according to claim 1, wherein, in the step (6), the ion exchange resin is Na-type cation exchange resin, and the pH value of the feed liquid is 3.5 to 5.5.
